(19) United States
(12) Patent Application Publication
(10) Pub. No.: US 2009/0097250 A1
(43) Pub. Date: Apr. 16, 2009

(54) Integrated battery charging work light electrical distribution system

(76) Inventors: Jeremy D. Leasure, Jackson, TN (US); Mark A. Etter, Humboldt, TN (US)

Correspondence Address: THE BLACK & DECKER CORPORATION, 701 EAST JOPPA ROAD, TW199, TOWSON, MD, 21286, US

(21) Appl. No.: 10/997,806

(22) Filed: Nov. 24, 2004

Related U.S. Application Data
(60) Provisional application No. 60/525,392, filed on Nov. 25, 2003.

(51) Int. Cl. F21V 33/00

(52) U.S. Cl. 362/253

(57) ABSTRACT

The present invention is directed to an apparatus for integrating various systems such as a battery charging system, an industrial lighting system and an electrical distribution system. The present invention may include an industrial light, a battery charging mechanism for recharging batteries of power tools, and an electrical distribution system allowing additional corded electric tools and appliances to receive power through the electrical distribution system of the apparatus. Additionally, a power surge protector may be included in the apparatus. The integration of various systems may reduce the number of appliances required at a jobsite, further reducing the clutter at the jobsite.

### CROSS REFERENCE TO RELATED APPLICATIONS

The present invention claims priority to U.S. Provisional Application Ser. No. 60/525,392 filed Nov. 25, 2004. Said U.S. Provisional Application 60/525,392 is hereby incorporated by reference.

### FIELD OF THE INVENTION

The present invention generally relates to the battery charging systems, and more particularly to a method and system for integrating a battery charging system and an industrial lighting system.

### BACKGROUND OF THE INVENTION

Construction performed at jobsites typically requires a variety of power tools, cordless tools, battery chargers, lighting systems and the like. This is very cumbersome for a construction worker when transporting tools, lights and battery chargers to and from the jobsite each shift, day, or the like. Another problem caused by the number of different tools and accessories required for construction is the clutter created at the jobsite by a separate light, a separate battery charger, separate power strips for power tools and power cords strewn across the jobsite to provide power from a power source remote to the location of the construction. This clutter may be hazardous for construction workers as they move around the jobsite to perform tasks associated with the construction. Consequently, an apparatus that could provide light, battery charging for rechargeable batteries of power tools, and additional electrical power is necessary.

### SUMMARY OF THE INVENTION

Accordingly, the present invention is directed to an apparatus for integrating a battery charging system, an industrial lighting system and an electrical distribution system. In one embodiment of the invention, an apparatus in accordance with the present invention may include a light, a receptacle for receiving rechargeable batteries and a plurality of electrical outlets allowing corded electric tools and appliances to receive power through the apparatus. Advantageously, this may reduce the number of appliances that a construction worker may need to transport to and from a jobsite and may also reduce clutter at the jobsite.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 depicts an illustration of an apparatus in accordance with an embodiment of the present invention;

FIG. 2 depicts a back view of an apparatus in accordance with an embodiment of the present invention;

FIG. 3 depicts a perspective view of an apparatus in accordance with an embodiment of the present invention;

FIG. 4 depicts electrical outlets and a switch located on the side of an apparatus in accordance with an embodiment of the present invention; and

FIG. 5 depicts an illustration of an apparatus in accordance with an alternative embodiment of the present invention.

### DETAILED DESCRIPTION OF THE INVENTION

Reference will now be made in detail to the presently preferred embodiments of the invention, examples of which are illustrated in the accompanying drawings.

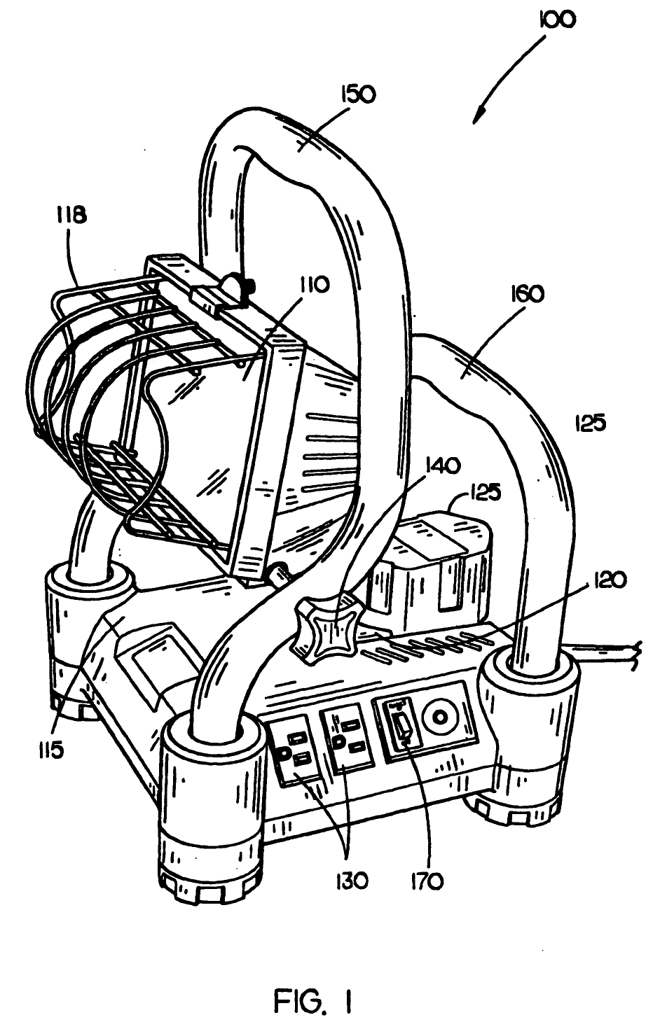

Referring to FIG. 1, an illustration of an apparatus 100 in accordance with an embodiment of the present invention is shown. Apparatus 100 may include a light 110, a housing 115 which includes a battery charger receptacle 120 for recharging a rechargeable battery 125 suitable for power tools and an electrical distribution system comprising multiple electrical outlets 130. Light 110 may be suitable for being adjusted to shine in a variety of angles through an angle adjuster 140. Additionally, the light may be surrounded by a cage 118 to prevent damage to the light 110.

In an advantageous aspect of the present invention, battery charger receptacle may be adjustable to operate with a variety of rechargeable battery of different manufacturers. Further, the rechargeable batteries may include lithium batteries, nickel cadmium batteries, nickel metal hydride batteries, lead-acid batteries, and the like. It is contemplated that when a rechargeable battery is placed within the battery charger receptacle, apparatus 100 may automatically begin recharging the rechargeable battery when the apparatus is receiving power itself. In an alternative embodiment of the invention, multiple battery charger receptacles may be included within housing of the apparatus 100 whereby multiple rechargeable batteries may be recharged simultaneously.

Apparatus 100 may receive power via a corded plug which may be connected to an AC outlet, a conventional wall outlet, a generator or the like. Apparatus 100 may include a light switch (not shown) and a power switch 170. Light switch may control power to the light 110 where power switch 170 controls power to the multiple electrical outlets 130. Apparatus 100 may further include a first handle 150 and a second handle 160 to allow easy transport of the apparatus 100 of the present invention to and from a jobsite. In one embodiment of the invention, light 110 may be mounted within the first handle 150 in conjunction with angle adjuster 140.

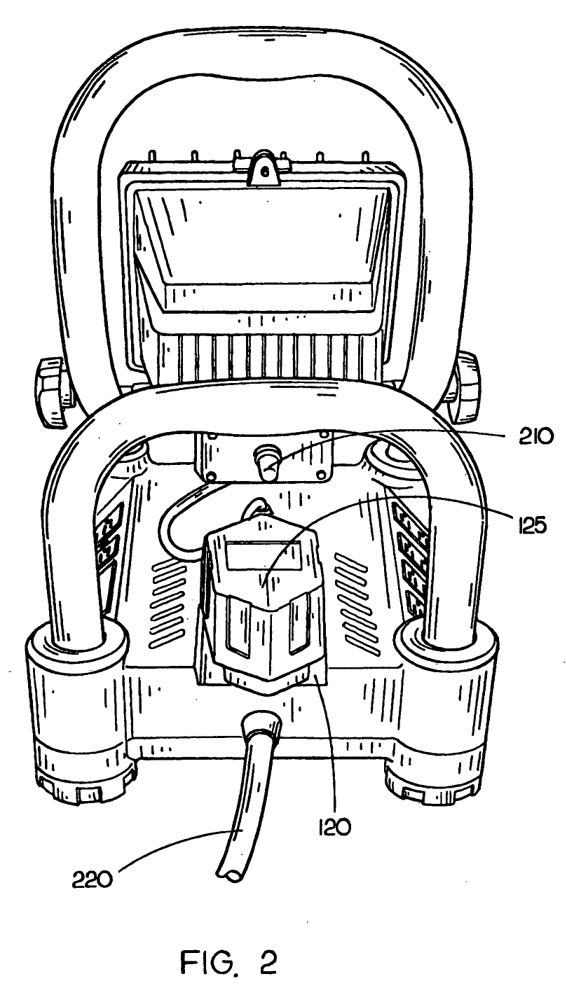

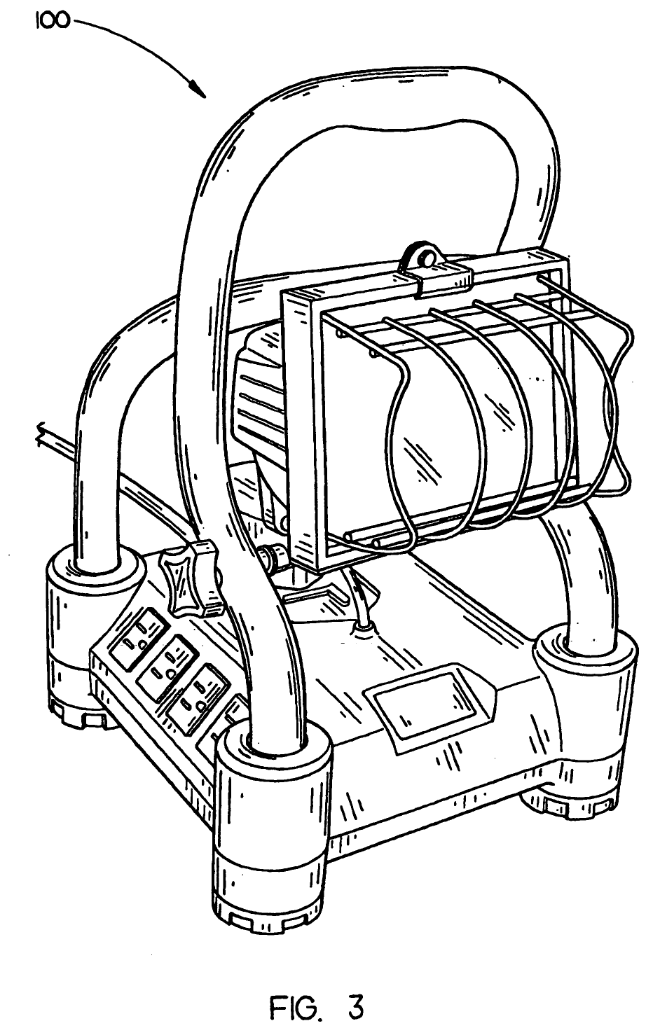

Referring now to FIG. 2, a back view 200 of the apparatus 100 in accordance with an embodiment of the present invention is shown. Light switch 210 may be placed on the backside of the light 110 to control power to the light. In an embodiment of the invention, light switch 210 may be a toggle switch. In a particular embodiment of the present invention, the apparatus 100 may comprise a visual indicator (not shown) for the battery charger 120. It will be appreciated that there are various ways to implement the visual indicator. For example, the visual indicator may be a LED light indicating whether the battery 125 is fully charged. The apparatus 100 may include an electric cord 220 whose opposite ends include an AC male plug, a DC plug or the like. FIG. 3 shows another illustration of the apparatus 100 in accordance with an embodiment of the present invention.

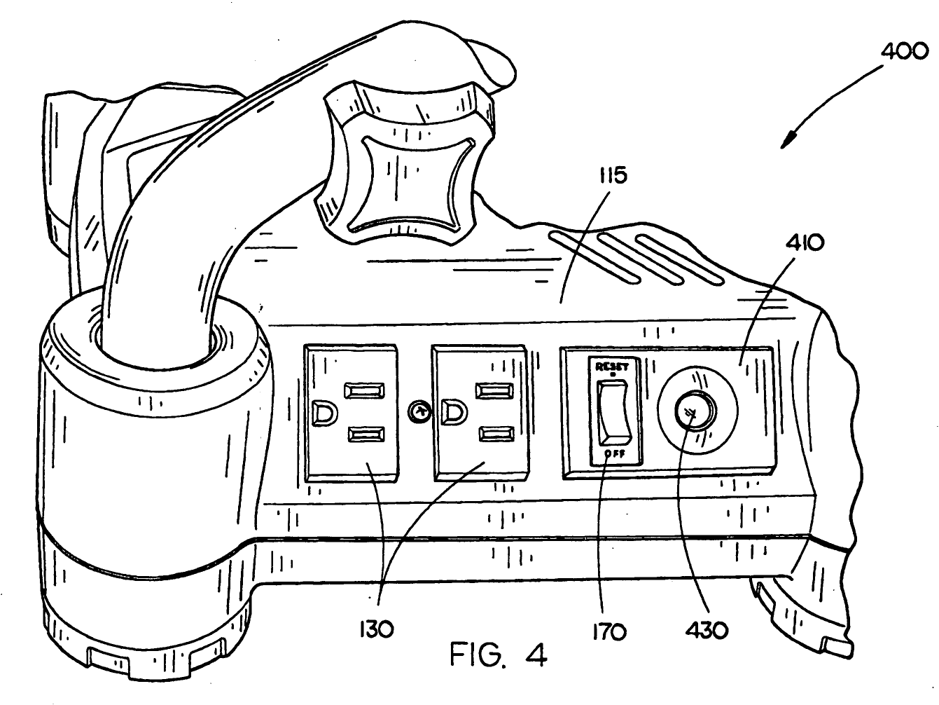

Referring now to FIG. 4, a side view 400 of the apparatus 100 in accordance with the present invention is shown. Multiple electrical sockets 130 may be provided on side portions of the housing 115 of the apparatus 100. Additional power tools may be powered from the multiple electrical outlets (sockets) 130 from the apparatus rather than running power cords to the electrical source. In this manner, the apparatus 100 of the present invention may serve as a power distributing system for additional power tools. In an embodiment of the present invention, the apparatus 100 may include a power surge protection 410 for the electrical outlets 130. The electrical outlets 130 may be turned off/on by a switch 170. A visual indicator 430 for the power surge protection may be located next to the switch 170 in order for the user to reset the electrical outlets when it is necessary.

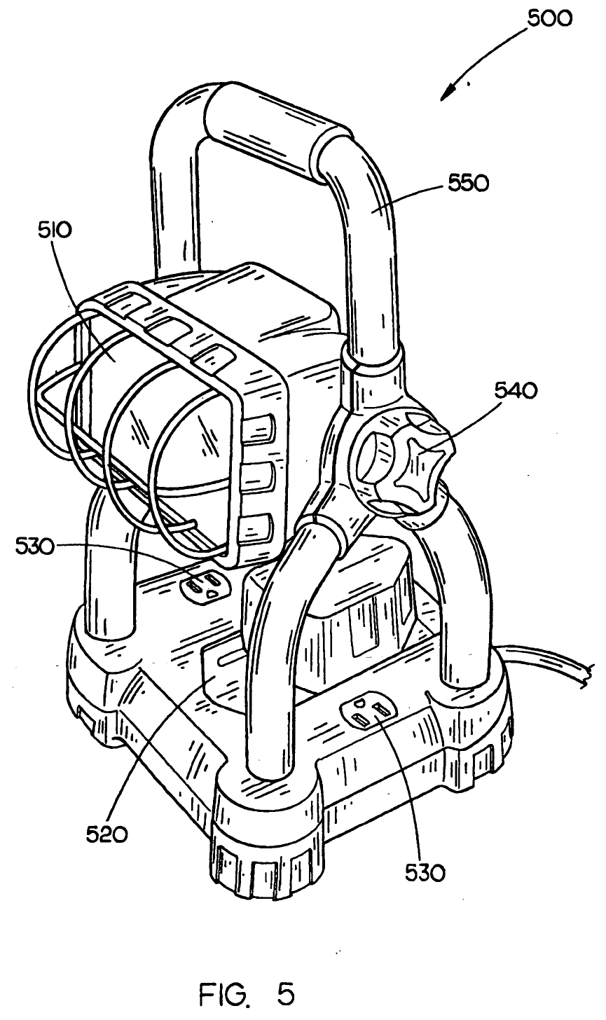

Referring now to FIG. 5, an illustration of an apparatus 500 in accordance with an alternative embodiment of the present invention is shown. The apparatus 500 may include a light 510, a battery charger 520 for rechargeable batteries suitable for power tools. The light 510 may be suitable for being adjusted to shine in a variety of angles through an angle adjuster 540 connected to a handle 550. Multiple electrical outlets 530 may be located on the top portion of the housing 115 of the apparatus 100. It will be appreciated that the location of the electrical outlets can be determined by various factors such as a size of the apparatus, or the like.

An advantageous aspect of the present invention is the resulting reduction of clutter at a jobsite since additional power tools may be powered from the apparatus rather than running power cords to the electrical source. Further, integration of the light and the battery charger may reduce the number of appliances required at the jobsite, further reducing the clutter at the jobsite. It is contemplated that the various components of the present invention may be integrated in a variety of way by those with skill in the art without departing from the scope and intent of the present invention.

It is believed that the apparatus of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

1. An apparatus, comprising:
a housing, said housing including at least one electrical outlet for electrical power distribution and a receptacle for receiving a rechargeable battery that is separable from the housing and connectable to a power tool; and
a light mounted to said housing, wherein electrical power received by the apparatus is distributed to said plurality of electrical outlets, said receptacle for receiving a rechargeable battery and said light.

2. The apparatus as described in claim 1, wherein a rechargeable battery is capable of being recharged when placed within said receptacle of said apparatus.

3. The apparatus as claimed in claim 1, further comprising an angle adjuster, said angle adjuster being coupled to said light.

4. The apparatus as claimed in claim 3, wherein said angle adjuster allows rotation of said light.

5. The apparatus as claimed in claim 1, further comprising a handle, wherein said light is attached to said handle.

6. The apparatus as claimed in claim 1, further comprising a surge protector coupled between power received by the apparatus and said plurality of electrical outlets.

7. The apparatus as claimed in claim 1, further comprising a power switch, said power switch controlling power to said plurality of electrical outlets.

8. The apparatus as claimed in claim 1, further comprising a light switch, said light switch controlling power to said light.

9. An apparatus, comprising:
a housing, said housing including a plurality electrical outlets for electrical power distribution and a receptacle for receiving a rechargeable battery, said receptacle being suitable for providing power to a rechargeable battery when a rechargeable battery is placed within said receptacle, the rechargeable battery being separable from the housing and connectable to a power tool;
a handle coupled to said housing; and
a light mounted to said handle, wherein electrical power received by the apparatus is distributed to said plurality of electrical outlets, said receptacle for receiving a rechargeable battery and said light.

10. The apparatus as claimed in claim 9, further comprising an angle adjuster, said angle adjuster being coupled to said light and said handle.

11. The apparatus as claimed in claim 10, wherein said angle adjuster allows rotation of said light.

12. The apparatus as claimed in claim 9, further comprising a surge protector coupled between power received by the apparatus and said plurality of electrical outlets.

13. The apparatus as claimed in claim 9, further comprising a power switch, said power switch controlling power to said plurality of electrical outlets.

14. The apparatus as claimed in claim 9, further comprising a light switch, said light switch controlling power to said light.

15. An apparatus, comprising:
a housing, said housing including a plurality electrical outlets for electrical power distribution and a receptacle for receiving a rechargeable battery, said receptacle being suitable for providing power to a rechargeable battery when a rechargeable battery is placed within said receptacle, the rechargeable battery being separable from the housing and connectable to a power tool;
a handle coupled to said housing;
a light mounted to said handle;
a light switch; and
a power switch, wherein electrical power received by the apparatus is distributed to said plurality of electrical outlets, said receptacle for receiving a rechargeable battery and said light, said distribution of power received by said apparatus being controlled by at least one of said light switch or power switch.

16. The apparatus as claimed in claim 15, further comprising an angle adjuster, said angle adjuster being coupled to said light and said handle.

17. The apparatus as claimed in claim 16, wherein said angle adjuster allows rotation of said light.

18. The apparatus as claimed in claim 15, further comprising a surge protector coupled between power received by the apparatus and said plurality of electrical outlets.

19. The apparatus as claimed in claim 15, wherein said power switch controls power to said plurality of electrical outlets.

20. The apparatus as claimed in claim 15, wherein said light switch controls power to said light.
